(19) United States
(12) Patent Application Publication
(10) Pub. No.: US 2008/0033805 A1
(43) Pub. Date: Feb. 7, 2008

(54) Digital wireless advertising

(76) Inventor: Jeffry Padin, El Segundo, CA (US)

Correspondence Address: MICHAEL RIES, 318 PARKER PLACE, OSWEGO, IL, 60543, US

(21) Appl. No.: 11/490,801

(22) Filed: Jul. 20, 2006

(51) Int. Cl. G06Q 30/00

(52) U.S. Cl. 705/14

(57) ABSTRACT

The present invention relates to a direct digital wireless marketing system and method. With the invention businesses can contract for advertisements to be transmitted from a radio data link covering the area surrounding the business and reaching multipurpose computers inside the cars as they travel within the area. The ads are in a digital format for display on the in-car computer. The in-car computer filters the ads transmitted from the businesses for only preselected items needed by the user. The businesses pay for the ads through the service provider that also setups the hardware and software. The businesses upload data regarding the ads they are transmitting to the service provider, so that the filtered advertisements are easily selected by the user via the service provider. Ads that appeal to the user can be stored for later use as needed in the multipurpose computer.

### TECHNICAL FIELD AND BACKGROUND

The present invention is a system and method in which business advertisement reaches a user through a wireless or radio data link between the individual business and a general purpose computer in the car as it travels pass the businesses location or within driving distance of the business location.

More specifically, the present invention is a system and method in which a user (consumer, user, buyer of in car computer, user of ad filtering web service or receiver of ads) creates a predetermined and/or adjustable filter which is used by the in-car computer to limit the number of advertisements to only those ads that the user wants to view and which are received by the general multi-purpose in-car computer as it travels past the business (merchant, business, organization or government advertiser) transmitting Direct Wireless Marketing (DWM) advertisements. These wanted advertisements are either viewed immediately in the car using the in-car computer or are stored for later use as needed. The wanted advertisements originate from businesses (merchant, business, organization or government advertiser) that are on the usual route of a buyer. Also other unwanted advertisements that are filtered out not wanted for exclusion of viewing in the car, can be stored for the user (consumer, user, buyer of in car computer, user of ad filtering web service or receiver of ads) for later use if wanted. The in-car computer on return home from a car trip can upload both the stored unwanted and wanted advertisements to the home computer. The home computer receives the unwanted and wanted advertisements in separate lists or files creating an e-shopper list. At home on the home computer, the user can choose which type of advertisements in the e-shopper list he wants displayed or printed or marked either the wanted advertisements or unwanted advertisements or both. Marked advertisements are ones that the user can command the home computer to upload back to the in-car computer along with written or GPS directions obtained from the internet for the merchant of the advertisement so that on the next trip the user can easily find the advertiser (merchant, business, organization or government advertiser).

Retail and service companies spend billions of dollars per year marketing their products and services, but much of their advertising dollars provide advertisements to the attention of the general public, which includes all people who would never be interested in the product using media like TV or radio. Advertising media like billboards or signs can be close to the location of the store, but also includes people who would never be interested in the using the product. Internet computer ads can in some instances be limited to only people who would use the product, but rarely are such ads directed to people who would want to use the product and have the ad delivered to them during unused free time and at times when they are passing near the store.

In the present invention, the concept of Direct Wireless Marketing (DWM) is an advertising service used with an in-car multipurpose (one not used for controlling the car engine) computer system having but not limited to ad-hoc wireless connections or connection to the internet and other computers with technology similar to cell phones G3, WiFi Bluetooth WiMax etc. The in-car computer and associated hardware may include or control many other features such as amplifier, radio, satellite radio, GPS etc. In this service, product sellers or advertiser (merchant, business, organization or government advertisers), can create and send any number of advertisements to a consumer (consumer, user, buyer of in car computer, user of ad filtering web service or receiver of ads) while he is doing nothing else but driving or riding to his usual destinations, yet the consumer can use the processing power in the in-car computer to view only those advertisements that he is interested in and also store selected ads for later use during his current or later shopping trips. This service represents the future of mass marketing in a more efficient and cost effective way by providing ads sent at convenient free times such as when driving, providing ads that are close to the location of the store, and providing convenient storage of advertisements for later use when the consumer actually does his buying trip.

A consumer (consumer, user, buyer of in car computer, user of ad filtering web service or receiver of ads) using the system of the present invention selects a product or products that he or she would be interested in buying on sale or regular price from a web-based software system that comes with the each multi-purpose in-car computer provided by the service provider (support provider or DWM provider). The products can be selected according to price range and even style. This creates a filter criteria of only the products the consumer is interested in viewing. With DWM the filtering criteria are loaded into the in-car computer. This is possible because the in-car computer can communicate wirelessly with the house computer. After the filtering criteria are loaded into in-car computer, the consumer will continue with his or her regular daily activities and travel plans in the car; including for example, going to work, the gym, visit friends, etc. As the consumer drives the car and passes by a retail store(s) that has a compatible Digital Wireless Marketing Service transmitter, the store will transmit any and all of its ads to the car. Repeater stations can be located in strategic places, in city buses, gas stations, electric car recharge stations or in taxis for transmission of the advertisements and reception at locations remote from the place of business of the advertiser. As the in-car computer receives those ads it will only select those ads that match the filter criteria of the consumer and a message regarding that is displayed on the units touch screen. The message or advertisement data could be a short text message or a voice message or graphics with audio message. A typical message will say: on the store to your left (store name will be mentioned) the item you are looking for is on sale. The message for the product or service remains in the in-car computer for later retrieval if the user can not make the purchase at the time and location of the store that is passed by the car. The later retrieval can include transmitting the ads back to the home computer for later storage and organization. This is a lot more efficient than trying to remember what a buyer hears on a radio commercial due to their short time span.

The DWM service includes a web based like service and is similar to a buying service where the consumer can make his own choices as to the kinds of advertisements he wants to view that are related only to the items he wants to purchase. The chosen list of advertisements are defined by the advertisements that the advertisers employing the DWM service upload to the web and wirelessly transmit to their areas. The areas transmitted to can be remote or local to the advertisers place of business. This is similar to users who tune in to shopping channel so they can leisurely watch for items they know they need or want to purchase. This is also similar to ebay.com to view only those auctions that pertain directly to those items they already know they need or want to purchase.

Once a product seller (merchant, business, organization or government advertiser) purchases the DWM service from the DWM service provider (support provider or DWM provider) it can broadcast any given number of products, or services continuously and non-stop for days, weeks or years, 24 hours of the day, 7 days a week. On special days or holidays, product sellers can easily and quickly change the advertisements that are broadcast. Any of the advertisements to be broadcast are sent by the seller to the DWM service provider via the DWM web service so that the consumer will have a defined list of advertisements to choose in his filter list.

The DWM service or web based service is also the perfect solution to today's new wave of uninterrupted audio (e.g. satellite radio) and video services. The DWM service advertisements can be offered in combination with the uninterrupted audio and video services like satellite radio services XM or Sirus. The DWM service advertisements maybe encrypted and then added to the uninterrupted satellite sourced audio and video signals. This means that the consumer's in-car computer would be able to tune in the uninterrupted video and audio via the in-car computer, and receive the DWM advertised services and products, while the in-car computer filters and then outputs only those ads that the user wants. Since the wanted items ad list or filtered list of ads is chosen by the user from the DWM service provider's website, local or national ads sent via satellite over wide areas can be filtered in the same manner. The DWM service offers the perfect marriage between uninterrupted audio and video and marketing because it allows the consumer to know about the products or services that the user is interested in purchasing, while enjoying non-stop audio and video services. Also, since advertisers using the DWM service would pay a premium for their ads to be heard or viewed by a larger number of DWM users via satellite, DWM users may subscribe to the satellite service at lower cost.

The service can also include but not limited to automatic welcome and information notices from government non-profit organizations as well as advertisements from merchants. These kinds of notices could be automatically sent when a driver enters a new state, which include lodging availability, restaurant, weather, traffic, information, special state laws, state geography, historical sites, etc. The notices could also include recreation park automated information, industrial complex general information, and/or limited-time-displayed danger area information. Emergency Alert System (EAS) is a national public warning system that, combined with other emergency notification systems, is part of an overall public alert and warning system. The Federal Communications Commission (FCC) has regulated the Emergency Broadcast System (EBS) and helped to transform EBS into the Emergency Alert System by reaching beyond traditional media to include cable systems and in 1997 wireless cable systems. DWM can provide sophisticated media rich services (text, video, audio, etc) and features to enhance the overall effectiveness of Emergency Broadcast System across the nation and to the general public. This would include, but not limited to, natural disasters, homeland security, nuclear, biological, or chemical state-wide or nation-wide crises, etc.

U.S. Pat. No. 5,627,549; “Dual Channel Advertising Referencing Vehicle Location”, issued to Park discloses a vehicle information device which collects information concerning specific geographic points of interest. The operator recalls for display such information, including direction and distance of travel to a designated geographic point of interest relative to a then-current vehicle location. A dual channel transmission is transmitted by voice broadcast and by data broadcast that provide advertisements. Upon hearing in the voice broadcast an advertisement of interest, the operator captures the associated data broadcast which include detailed text message information and the location of the advertiser. Distance and relative direction of travel from the current vehicle location to the geographic point of interest is thereby presented. Multiple geographic points of interest are stored for selective review whereby the user constructs a database containing locations of particular interest to a particular person.

In the '549 reference, the advertiser does not subscribe to a system either for setting up his wifi or radio broadcast equipment or to have the merchant's list of advertisements put up on the web site for later use in creating a filtered list of advertisements that the user prefers to hear or see while driving in his car. Secondly, the user does not get to choose preferred advertised items downloaded from the web site and does not have the list loaded into to the car computer before travel so that only the preferred ads are seen or heard while driving. In the reference, the user listens to all voice broadcast advertisements in the car to choose and select preferred ones while in the car, and uses an in-car computer or other device like a notepad for storage and location finding. In the present invention the user database list contains items that can be both location or route sensitive to the trip as well as include those items that may not be on the trip route. In the present invention, the user may choose items that may be on alternate or later routes or trips or ones stored from previous trips. The reference also appears to be limited to advertisements that are location and time sensitive only. The reference is very dependent on GPS location finding and storage of ads only in the car, whereas the present invention includes the choice of ads to be viewed to be accomplished on the home computer where there is temporary storage before the download to the car computer. The reference also does not suggest or enable the use of graphically displayed ads.

### BRIEF DESCRIPTION OF THE DRAWINGS

The present invention will be described by way of exemplary embodiments, but not limitations, illustrated in the accompanying drawings in which like references denote similar elements, and in which:

FIGS. 1A and 1B are an environmental drawing of the digital wireless marketing system and method, in accordance with one embodiment of the present invention;

FIG. 2 is flow chart illustrating the method of the digital wireless marketing, in accordance with one embodiment of the present invention;

FIG. 3 is flow chart illustrating the method of the digital wireless marketing, in accordance with a further embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase agenerally” does not refer to the same embodiment, however, it may. The terms “comprising”, “having” and “including” are synonymous, unless the context dictates otherwise.

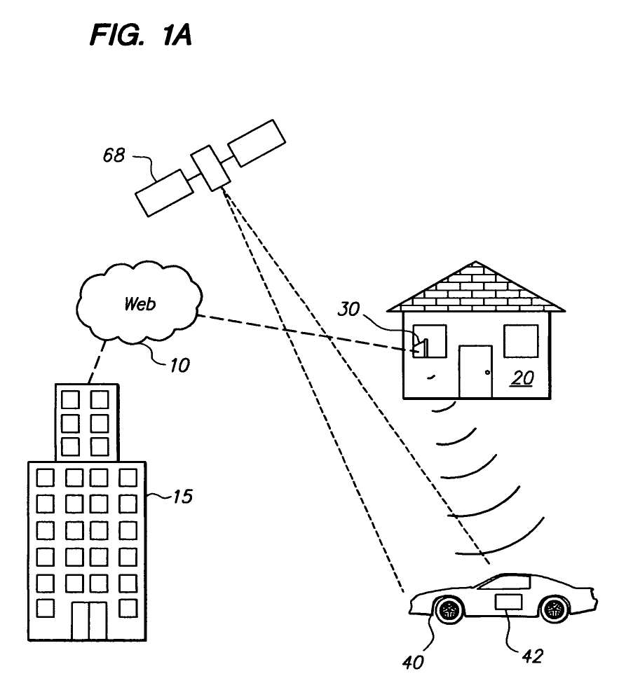

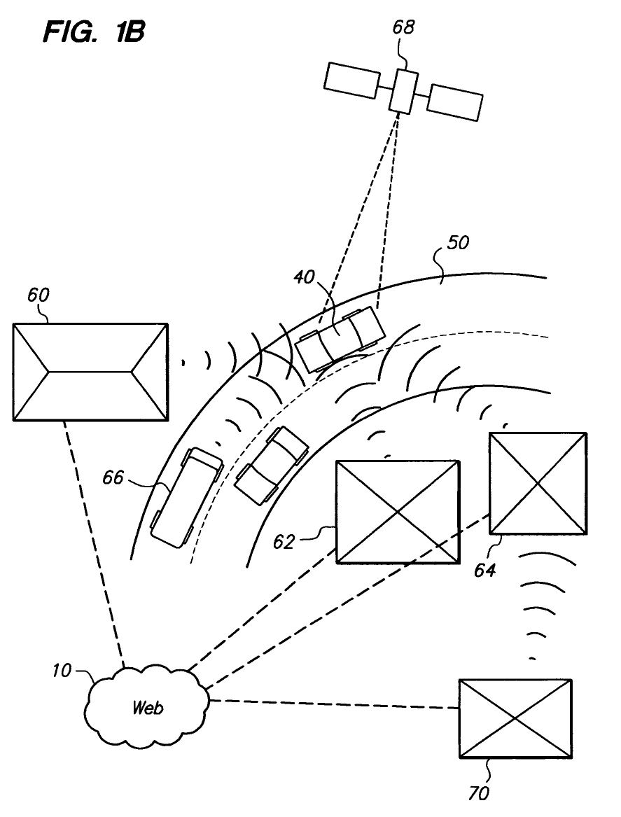

In an embodiment, the Direct Wireless Marketing consists of several sections of a complete system and method. The system is shown in the metropolitan layout in FIGS. 1A and 1B. The hardware section comprises an in-car computer 42 and the consumer's home 20 and computer 30 connected to the internet 10. The in-car computer 42 maybe connected to the internet occasionally and wirelessly. The software section consists of filtering and display software in the in-car computer 42; the browser and/or other utility software on the consumer's home computer 30 and the DWM server provider software. A separated part of the software is provided by the DWM service provider 15 and is the advertisement creation software. The DWM can provide wireless transmission hardware to the advertiser (merchant, business, organization or government advertisers) 60, 62, 64 and 70 or the advertiser provides its own hardware. The two entities advertiser 60-64, 70 and consumer are connected together by the internet 10 and web based service provider 15.

Merchants 60, 62, 64, 70, wanting to use this system of direct, location oriented advertising, contract with the web based service provider 15, who provides each merchant 60-64, 70 with wireless data transmission hardware to allow merchants own computer to transmit advertisements. Service provider 15 will provide via their website software that allows the merchant 60-64, 70 to create, edit etc. their advertisements. Instead of wireless data transmission hardware, the service provider 15 may provide the means for the merchant's advertisement to be transmitted to the users car 40 computer 42 via satellite 68 over continental areas or repeaters over metropolitan areas like those on building 64 nearby to road 50, which transmits for merchants in far away building 70. Also as shown the repeater or repeaters might be on other moving vehicles such as buses 66. Software via the advertiser's computer or the repeater transmits the created advertisements to cars 40 on road 50 passing by the merchant 60-64, 70 via the merchant's wireless data transmission hardware or the repeater. The software in the advertiser's computer also then uploads the created advertisements via the internet 10 to the service provide 15 for storage and later sorting and viewing by the consumer at home 20.

The consumer then uses his software on his home computer 30 to connect to the service provider 15 via internet 10, in order to choose what merchants advertisements he might want to eventually purchase and view. The client advertisers 60-64, 70 and users interaction with the service provider 15 is done via the internet with server software on the web site of the service provider 15.

For example, the user might be interested in tennis shoes, certain DVD movies, (patent) lawyer services etc. The user may choose any number of these items from those items provided by the service provider 15 which are amongst those created by the merchants 60-64, 70 and transferred to the service provider 15 via the internet 10. The software then produces a list of these wanted items in a format usable by the user's in-car computer 42.

The user then uses the software in his home computer 30 to upload the chosen list of wanted advertising items to the in-car computer 42 via a wireless transmitter connected to the home 20 computer 30 and a wireless receiver connected to the in-car computer 42. The in-car computer 42 can later use the wanted ad list as filter when he travels down the usual roads 50 that the user uses in his regular routine.

The in-car computer 42 and included software may be purchased or contracted for from the service provider 15 by the user. The in-car computer 42, provides many new technical features and services such as: MP3 and CD player using any kind of storage, FM listening, TV and/or DVD video viewing, play list or guide management of the above, GPS and map viewing, vehicle maintenance logs, vehicle repair manuals, vehicle to vehicle communication, vehicle to house communication (both data and voice), hands free cell phone, car security, virtual dashboard for air conditioning etc. and satellite radio 68. Some of the above services and features maybe included or provided by the service provider 15 or by other providers. Some of the services might include monthly subscriptions. Service provider 15 becomes a facilitator or collaborator for all these features and services and in addition collects revenue from the advertisers 60-64, 70. Some of the above features and services that the service provider 15 facilitates are paid for or subscription services, which can be provided at no or low cost to the user and his in-car computer 42 based on the revenues collected from the advertisers 60-64, 70. Some of these services include: satellite radio 68 having video and/or audio or other multimedia.

Thus, a wireless receiver in the in-car computer 42 receives all advertisements transmitted from the merchants 60-64, 70 while traveling down the road 50. The in-car computer 42 uses the wanted ad list as filter to present only those ads the consumer is interested in and in doing so the consumer has some the above subscription services and features paid for or partly paid for by the service provider 15 or merchants 60-64, 70.

As the user drives his car having in-car computer 42 down the road(s) 50 to his normal usual destinations, he maybe using his in-car computer 42 for any and all of the above features and services and at the same time the wireless receiver included in the in-car computer 42 will receive any and all advertisements for the merchants 60-64, 70 that are transmitting ads regardless of transmission device or means. The in-car computer 42 will use the list of chosen and downloaded items to filter through the transmitted advertisements from the merchants 60-64, 70 and display only those advertisements that correspond to the list. Only the advertisements matching those items on the wanted list are presented to the user in the car 40 via audio, and video (text or graphic) outputs connected to the in-car computer 42.

For example, the consumer of in-car computer 42 may want to receive satellite radio 68 but not wish to pay the monthly subscription fees usually involved. In order to enjoy the full experience satellite radio without the usual random advertisements like that found on normal analog AM or FM radio, the user can sign up for the ad filtering DWM service from the service provider 15. Merchant's 60-64 represent a number of merchants who would want to lower the cost of their ads while increasing there effectiveness and therefore use and setup with the service provider 15. The merchants 62-64 only have to send back to the service provider 15 the list of those items they will be advertising and transmitting wireless to the cars 40 on the road 50. The user can then preload a list into the in-car 42 computer only those items he may interested in amongst all the merchant 60-64, 70 that will be transmitting advertisements in the users metropolitan area. Suppose the user choose 2 items that are only available for sale and on advertisement from merchant 60. Therefore, as the user drives by merchants 60-64, 70 on road 50 the in-car computer 42 disrupts the users satellite radio listening 68 when it receives an advertisement only from merchant 60 regarding the two items. All other items advertised and transmitted from all merchants 62-64, 70 will not be presented and will never disturb the rest of the users satellite radio 68 listening regardless of when or at what point along the road 50 the car 40 is at. In addition, since the in-car computer 42 has many programmable options, the user does not have to be presented with an advertisement from merchant 60 for the two items in a manner that completely disrupts listening to satellite radio 68. This is possible because the in-car computer 42 can present the advertisements as text or graphics on a display device connected to the computer 42 inside the car 40.

In addition, the programmable options of an in-car computer 42 allows the user to bookmark or store either of the two items advertised from merchant 60 for later use. This is especially useful if the user does not have time to pull over or turn around and purchase the product immediately while on the way to an important meeting. In fact, he can create a shopping list for later use from stored items when going on a later shopping trip, and list will have items that are on the route(s) that the user normal drives or travels. The user does not need to remember to previous wanted items from his last shopping trip or drive. This shopping list for the later shopping trip can also include written directions, maps, GPS data of location of merchant's location downloaded from the service provider's 15 web site so that user can navigate and locate the shop of the merchant's business or building 60 using the in-car computer 42. If the merchant 60-64, 70 is broadcasting the wireless advertisements local to his business location the in-car computer 42 may have software to zero in on or display the signal strength of the wireless signal to further assist the user in locating the shop of the merchant 60.

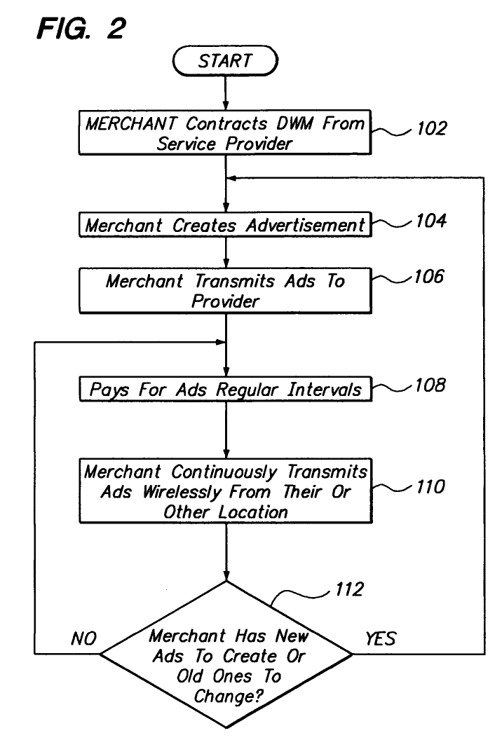

The following discussion of the method by which the merchant interfaces and operates with the digital wireless marketing is made in regard to FIG. 2. First at step 102 the merchants contracts with the service provider for the setup and purchase of the software for creating the ads on the merchant's computer and setup and purchase of the necessary wireless data transceiver hardware and the setup and agreements of regular payments for using the service provided by the service provider. Second at step 104, the merchant creates the advertisements in a format compatible with the car computer and the database that service provider provides to the user over the internet 10. Third at step 106, the merchant transmits the advertisements to the service provider over the internet 10. Fourth at step 108, the merchant 60 makes any necessary regular or scheduled payment for using the advertising service. Fifth at step 110, the merchant continuously transmits the advertisements in wireless data format in a form suitable for the car computer in the area near the merchant. Other areas too large for advertisers wireless hardware to transmit to can be provided via service provider 15 wireless data hardware in repeaters on buses, on other building or in satellites can be used via different advertising costs. Then at step 112, does the merchant have new advertisements to create or old ones to change? If so then the steps above are repeated from step 104 and on. If not, then the steps above from step 108 and on are repeated.

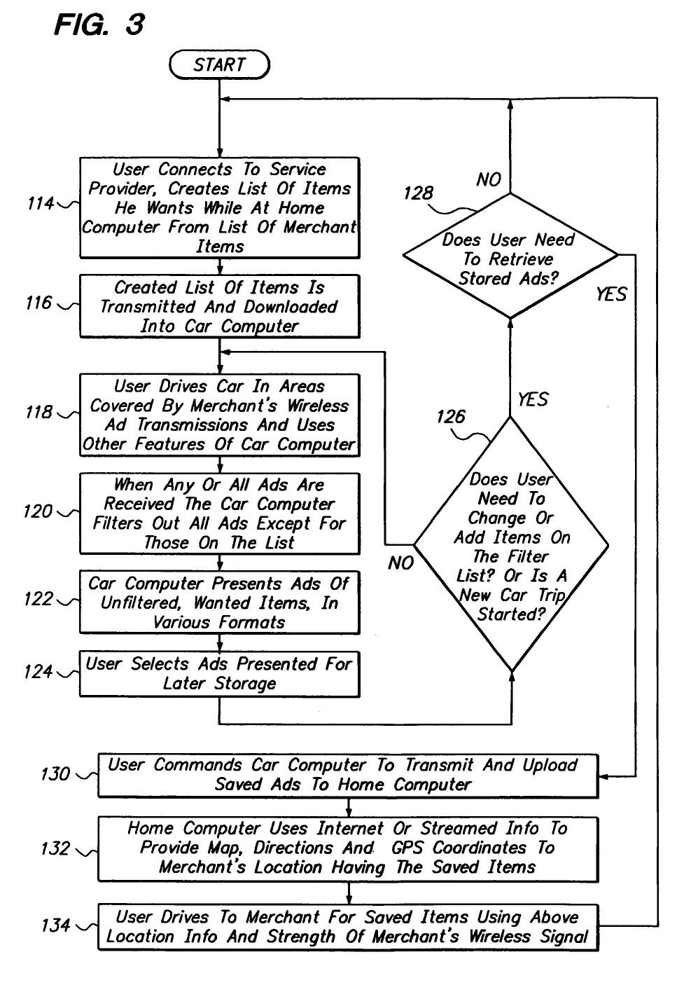

The following discussion of the method by which the user, the in-car computer and home computer operate with the digital wireless marketing service is made in regard to FIG. 3. At the start the user purchases and has the in-car computer and/pr software installed via a contract with the service provider and makes contract, agreements and setup (ie. software) with the service provider. Next at step 114, the user connects to the service provider via the internet 10 using his home computer 30 with the installed software from the service provider and creates a list of items he wants to eventually purchase or is serious about buying from amongst those items advertised by the merchants as in step 104 of FIG. 2. Step 114 is possible via the in-car computer

In step 116, the created list of chosen items is transmitted and downloaded as data into the in-car computer wirelessly from the home computer. Also, GPS and map location data regarding advertisers and advertisement location maybe downloaded and transmitted. Step 116 may be skipped and accomplished direct in the in-car computer. Also, at step 116 the saved or bookmarked items are downloaded from the home computer to the in-car computer.

In step 118, the user drives his car in areas covered by the merchants wireless data advertisement transmissions and the user uses the other features and services provided by the in-car computer while going about the users car trip. At step 120, when advertisements for any or all merchants are received the in-car computer filters out all advertisements except those on the list. At step 122, the in-car computer presents the filtered advertisements in various or selectable formats with regards to the display and output devices connected to the in-car computer. At step 124, as the filtered advertisements (only those ads wanted by the user and available from an advertisers transmissions) are presented the user can select certain ones of the advertisements for storage and later use. The user might do this via a touch screen display output connected to the in-car computer. Then at step 126, does the user need to change or add any or all of the advertisements on his filter list? This would likely occur at the beginning of a new car trip or the end of the current car trip. If he does not need to change the list, then steps 118 to 124 are repeated. If he does need to change his filter list, then at step 128, does the user need to retrieve any advertisements that he has stored in the in car computer? If the user does not have any stored advertisements to retrieve then steps 114 to 124 are repeated. If the user does have any stored advertisements to retrieve, then at step 130, the user commands the in-car computer to transmit and upload any saved items to his home computer wirelessly.

In the above methods and explanations, the filtered list of ads or wanted item list is created through user input on the user's computer and the service provider's 15 internet 10 web site which is not limited to locality. Thus, it is possible the actual transmissions of an advertiser's ad can be transmitted from a satellite 68 over a continental area (continental repeater) or repeater over a metropolitan area, such as building 64 transmitting for building 70, or another moving vehicle such as a bus 66. The extra feature of satellite 68 transmissions to the car 40 computer 42 may include paid for audio and/or video service as well as the preselected advertisements which allows the user to receive the audio and/or video services for free or reduced rate as mentioned above. While the main feature of the invention in which the user receives only those ads that he previously choose to view or hear via the wanted item list stored in the car computer 42 remains operationally the same.

While the present invention has been related in terms of the foregoing embodiments, those skilled in the art will recognize that the invention is not limited to the embodiments depicted. The present invention can be practiced with modification and alteration within the spirit and scope of the appended claims. Thus, the description is to be regarded as illustrative instead of restrictive on the present invention.

What is claimed is:

1. A method for direct wireless marketing comprising:
creating advertisements by at least one advertiser involved with the wireless marketing;
transmitting the created advertisements to a service provider;
providing payment to the service provider from the at least one advertiser for distributing the created advertisements;
transmitting the created advertisements wirelessly from the at least one advertiser location to a surrounding area;
connecting a user to the service provider for receiving the created advertisements;
creating a list of items the user wants from the received advertisements;
transmitting the list of wanted items to a computer in a car of the user;
receiving wirelessly the created advertisements transmitted to the surrounding area at the computer in the car, while the car is driven through the surrounding area;
filtering out those created advertisements that do not match the items on the wanted list by the computer in the car; and,
presenting advertisements matching the items on the wanted list by the computer in the car.

2. The method for direct wireless marketing of claim 1 wherein when the advertiser has new advertisements to create or old advertisements to change the steps of creating and transmitting above are repeated; and,
including a step of recalculating payment to the service provider; and,
when the advertiser has no new or changed advertisements the advertiser continues to provide scheduled advertising payments to the service provider.

3. The method for direct wireless marketing of claim 1 wherein when the user needs a changed list of wanted items, the steps of connecting the user, creating the list, transmitting the list, receiving wirelessly the created advertisements, filtering out created advertisements and presenting advertisements are repeated.

4. The method for direct wireless marketing of claim 2 wherein when the user needs a changed list of wanted items, the steps of connecting the user, creating the list, transmitting the list, receiving wirelessly the created advertisements, filtering out created advertisements and presenting advertisements are repeated.

5. The method for direct wireless marketing of claim 1 comprising: selectively storing the wirelessly received created advertisements and the advertisements matching the wanted items list in the car computer.

6. The method for direct wireless marketing of claim 1 comprising:
wherein the step of transmitting the list includes transmitting map and GPS data regarding the location for each of the wanted item list;
selecting one of the advertisements from the wanted item list by the user while driving;
retrieving the map and GPS for the advertiser's store corresponding to the selected advertisement and;
presenting the maps and GPS data on the car computer to assist the user in finding and locating the store of the selected advertiser advertisement.

7. The method for direct wireless marketing of claim 1 comprising the step of connecting the user to the service provider uses a computer in a house of the user having a connection to the internet;
the step creating the list of items the user wants is accomplished on the computer in the house; and,
the step of transmitting the list of wanted items to the computer in the car includes transmission from the house computer to the car computer of data for the created list of wanted items.

8. The method for direct wireless marketing of claim 1 comprising:
the steps of connecting the user to the service provider uses the computer in the car having a connection to the internet;
the step creating the list of items the user wants is accomplished in the computer in the car; and
the step of transmitting the list of wanted items to the computer in the car is not required.

9. The method for direct wireless marketing of claim 1 wherein the car computer provides additional features some of which require regular payments and in which such regular payments are less while the user uses the direct wireless marketing.

10. The method for direct wireless marketing of claim 9 wherein one of the additional features is satellite transmissions of multimedia programs to the user.

11. The method for direct wireless marketing of claim 2 wherein the car computer provides additional features some of which require regular payments and in which such regular payments are less while the user uses the direct wireless marketing.

12. The method for direct wireless marketing of claim 11 wherein one of the additional features is satellite transmissions of multimedia programs to the user.

13. The method for direct wireless marketing of claim 5 comprising
the step of connecting the user to the service provider uses a computer in a house of the user having a connection to the internet;
recalling the selectively stored advertisements from the car computer on the computer in the house;
the step of creating the list of items the user wants is accomplished on the computer in the house; and,
the step of transmitting the list of wanted items to the computer in the car includes transmission from the house computer to the car computer of data for the created list of wanted items and the selectively stored advertisements.

14. The method for direct wireless marketing of claim 1 wherein the surrounding area of the transmissions are local to the place of business of the at least one advertiser.

15. The method for direct wireless marketing of claim 1 wherein the surrounding area of the transmissions are remote to the place of business of the at least one advertiser.

16. The method for direct wireless marketing of claim 15 wherein the remote surrounding area of the transmissions are accomplished by repeaters.

17. The method for direct wireless marketing of claim 1 wherein the surrounding area of the transmissions are at variable distances from the place of business of the at least one advertiser.

18. The method for direct wireless marketing of claim 1 wherein the surrounding area of the transmissions are spread over a large continental area.

19. The method for direct wireless marketing of claim 18 wherein the large continental area is provided by satellite transmissions.

20. The method for direct wireless marketing of claim 19 wherein one of the additional features is satellite transmissions of multimedia programs to the user which requires regular payments and in which such regular payments are less while the user uses the direct wireless marketing.

21. The method for direct wireless marketing of claim 1 wherein the advertiser is a government organization providing emergency information.

22. The method for direct wireless marketing of claim 14 wherein a signal strength of the local transmissions and the in-car computer further assist the user in finding and locating the store of the advertiser.

23. The method for direct wireless marketing of claim 10 wherein at least one of the plurality of features is emergency information.

24. The method for direct wireless marketing comprising:
creating advertisements by at least one advertiser involved with the wireless marketing;
transmitting the created advertisements to a service provider;
providing payment to the service provider from the at least one advertiser for distributing the created advertisements;
transmitting the created advertisements wirelessly from the at least one advertiser location to a surrounding area;
connecting the user to the service provider uses a computer in the car having a connection to the internet;
creating the list of items the user wants is accomplished in the computer in the car;
selectively storing the wirelessly received created advertisements and the advertisements matching the wanted items list in the car computer for later use in the selected one of the car computer and home computer;
data for the created list of wanted items and the selectively stored advertisements are available in the car computer;
receiving wirelessly the created advertisements transmitted to the surrounding area at the computer in the car, while the car is driven through the surrounding area;
filtering out those created advertisements that do not match the items on the wanted list by the computer in the car; and,
presenting advertisements matching the items on the wanted list by the computer in the car.

25. A computer and hardware in a vehicle of a user comprising:
a plurality of features provided by the computer and hardware in the vehicle of the user;
a computer provided by at least one advertiser for creating advertisements;
the at least one advertiser computer for transmitting the created advertisements to a service provider via the internet;
the at least one advertiser computer for providing payment to the service provider via the internet;
a wireless data transceiver connected to the advertiser computer provided for or by at least one advertiser and for transmitting wireless advertisements to a surrounding area;
a home computer of the user to connect the user to the service provider to receive the created advertisements;
the home computer of the user to create a list of wanted items the user wants from the received created advertisements;
a wireless data transceiver in the vehicle computer to receive the list of wanted items that correspond to wanted advertisements from the home computer of the user;
audio and video outputs in the vehicle computer to output only those wirelessly transmitted advertisements which the vehicle computer match with items on the wanted list.

26. The computer and hardware in the vehicle of the user of claim 25 wherein at least one of the plurality of features are paid for at least in part by the at least one advertiser providing the wireless advertisements through the service provider.

27. The computer and hardware in the vehicle of the user of claim 26 wherein the at least one of the plurality of features is satellite transmissions of multimedia programs to the user.

28. The computer and hardware in the vehicle of the user of claim 25 wherein the surrounding area is remote to the place of business of the advertiser.

29. The computer and hardware in the vehicle of the user of claim 25 wherein the advertiser is a government organization providing emergency information.

30. The computer and hardware in the vehicle of the user of claim 25 wherein at least one of the plurality of features is emergency information.

31. The computer and hardware in the vehicle of the user of claim 25 wherein the user selectively stores the matched wirelessly transmitted advertisements for later use.

32. The computer and hardware in the vehicle of the user of claim 26 wherein the wireless data transceiver in the vehicle computer receives the list of wanted items and selectively stored advertisements.

33. The computer and hardware in the vehicle of the user of claim 26 wherein the wireless data transceiver in the vehicle computer receives the list of wanted items and selectively stored advertisements and GPS and map data regarding the list of wanted items and the selectively stored advertisements.
